(19) United States
(12) Patent Application Publication
(10) Pub. No.: US 2009/0295726 A1
(43) Pub. Date: Dec. 3, 2009

(54) Angle adjustable computer mouse that can be used with either hand

(76) Inventor: Kozo Kimura, San Bruno, CA (US)

Correspondence Address: Kozo Kimura, #15, 140 San Marco Ave, San Bruno, CA, 94066, US

(21) Appl. No.: 12/156,088

(22) Filed: May 28, 2008

(51) Int. Cl. G06F 3/033

(52) U.S. Cl. 345/163

(57) ABSTRACT

An angle adjustable computer mouse that allows users to adjust angles to their preferred positions and allows usage for both right handed and left handed users by simply sliding the top component of the computer mouse over the base component of the computer mouse.

### FIELD OF THE INVENTION

The present invention relates to a computer mouse, specifically to the adjustable angle of the computer mouse.

### BACKGROUND OF THE INVENTION

Many computer users suffer wrist and forearm injuries as a result of computer mouse usage and are looking to purchase an ergonomic computer mouse as a possible solution. Unfortunately, a standard ergonomic mouse has only one set angle and does not always meet each individual's specific needs. Furthermore, there is not an ergonomic computer mouse available that can be used by both left handed and right handed users.

It would be advantageous to provide a computer mouse with adjustable angles that would accommodate each individual's body structure and comfort zone.

It would also be advantageous to provide a so called reversible computer mouse with adjustable angles that would give wider availability to left handed users.

It would further be advantageous to provide a reversible computer mouse with adjustable angles that would spare manufactures the extra cost of making both right handed and left handed versions for the same model.

### SUMMARY OF THE INVENTION

In accordance with the present invention, there is provided an angle adjustable computer mouse that users can change angles to their preferred angle position by simply sliding the top component of the mouse over the base component.

### BRIEF DESCRIPTION OF THE DRAWINGS

A complete understanding of the present invention may be obtained by referencing the accompanying drawings, when considered in conjunction with the subsequent, detailed description, in which:

FIG. 1 is a rear perspective view of the computer mouse in accordance with the invention;

FIG. 2 is a sectional side view of the computer mouse;

FIG. 3 is a basic rear view that shows the adjustable top component;

FIG. 4 is a rear view with the top component tilted to a low angle for right handed users;

FIG. 5 is a rear view with the top component tilted to a high angle for right handed users;

FIG. 6 is a rear view with the top component tilted to a low angle for left handed users; and

FIG. 7 is a rear view with the top component tilted to a high angle for left handed users.

For purposes of clarity and brevity, like elements and components will bear the same designations and numbering throughout the figures.

### DESCRIPTION OF THE PREFERRED EMBODIMENT

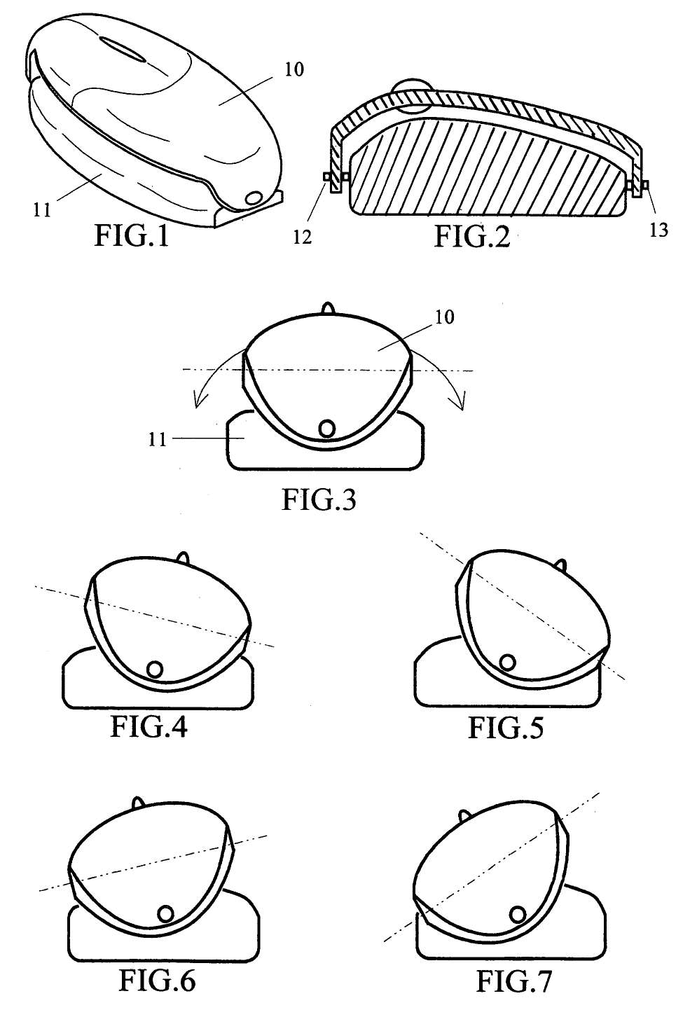

FIG. 1 is a perspective rear view. The top component 10 slides over the base component 11.

FIG. 2 is a sectional side view. The top component 10 adjusts to the front side pivot point 12 and the rear side pivot point 13

FIG. 3 is a basic rear view that shows the top component 10 is moveable.

FIG. 4 is a rear view with the top component 10 tilted to a low angle for right handed users.

FIG. 5 is a rear view with the top component 10 tilted to a high angle for right handed users.

FIG. 6 is a rear view with the top component 10 tilted to a low angle for left handed users.

FIG. 7 is a rear view with the top component 10 tilted to a high angle for left handed users.

### DRAWINGS—REFERENCE NUMERALS

Reference #10 Top component of the computer mouse

Reference #11 Base component of the computer mouse

Reference #12 Front side pivot point

Reference #13 Rear side pivot point

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims:

1. An angle adjustable computer mouse that can be angle adjusted to the preferred position of either a right handed or left handed user, comprising of:
a. A top component, for supporting the palm of the user's hand which can slide over the base component to adjust the angle of the computer mouse; and
b. A base component, for supporting the entire unit and all of its adjustable features.
